(19) United States
(12) Patent Application Publication
(10) Pub. No.: US 2026/0300161 A1
(43) Pub. Date: Oct. 1, 2026

(54) DATA STORAGE DEVICE FOR MANAGING PAGE STATUS INFORMATION, OPERATING METHOD OF THE DATA STORAGE DEVICE, AND MEMORY CONTROLLER FOR THE DATA STORAGE DEVICE

(71) Applicant: SK hynix Inc., Gyeonggi-do (KR)

(72) Inventor: Jae Youn JANG, Gyeonggi-do (KR)

(21) Appl. No.: 19/312,298

(22) Filed: Aug. 28, 2025

(30) Foreign Application Priority Data
Mar. 26, 2025 (KR) 10-2025-0038706

(51) Int. Cl. G06F 12/02; G06F 12/0804; G06F 12/0882

(52) U.S. Cl. CPC G06F 12/0246; G06F 12/0804; G06F 12/0882

(57) ABSTRACT

A data storage device may include a storage medium including a plurality of pages and a memory controller configured to manage whether each of the plurality of pages has validity, wherein the memory controller is configured to, update the validity information for a first page in the valid page caching table when the address of the first page, a status of which has changed, falls within the preset address range, and determine whether to flush the valid page caching table to the valid page table when the address of the first page, the status of which has changed, does not fall within the preset address range.

### CROSS-REFERENCES TO RELATED APPLICATION

This application claims priority under 35 U.S.C. § 119(a) to Korean Patent Application No. 10-2025-0038706, filed on Mar. 26, 2025, the entire contents of which are incorporated herein by reference.

### BACKGROUND

### 1. Technical Field

Various embodiments of the present disclosure relate to a semiconductor integrated device, and more particularly to a data storage device for managing page status information, an operating method of the data storage device, and a memory controller for the data storage device.

### 2. Related Art

A data storage device may use a nonvolatile memory device as a storage medium.

A storage medium such as a flash memory device may be composed of a plurality of pages, and due to the characteristic thereof that makes in-place updates difficult, whether each page stores valid data may be managed as page status information.

The status information of each page, that is, validity, may be changed due to a program operation or an erase operation in response to a request from an external device, or the internal management operation of the data storage device.

Although a storage medium may be efficiently managed by managing the validity of each page using a valid page table, overhead required to update the valid page table may degrade service performance for the external device.

### SUMMARY

Embodiments of the present disclosure may provide a data storage device that is capable of reducing overhead (e.g., latency of memory access operations, CPU cycle consumption for metadata management, and bandwidth usage for data transfer between memory controller and storage medium) required to update a valid page table, an operating method of the data storage device, and a memory controller for the data storage device.

In an embodiment of the present disclosure, a data storage device may include a storage medium including a plurality of pages to which addresses are respectively allocated, the plurality of pages including a first page; a memory controller configured to manage validity information for each of the plurality of pages; a first memory device configured to store, under control of the memory controller, a valid page caching table including the validity information for pages, the addresses of which fall within a preset address range among the plurality of pages; and a second memory device configured to store, under control of the memory controller, a valid page table including the validity information for each of the plurality of pages. Wherein the memory controller is configured to update the validity information for the first page in the valid page caching table when the address of the first page, a status of which has changed, falls within the preset address range, and determine whether to flush the valid page caching table to the valid page table when the address of the first page, the status of which has changed, does not fall within the preset address range.

In an embodiment of the present disclosure, an operating method of a memory controller for controlling a storage medium including a plurality of pages, to which addresses are respectively allocated, the plurality of pages including a first page, and includes, updating validity information for the first page in a valid page caching table, which is stored in a first memory device, when an address of the first page, a status of which has changed, falls within a preset address range of the valid page caching table; and determining whether to flush the valid page caching table to a valid page table, which is stored in a second memory device, when the address of the first page, the status of which has changed, does not fall within the preset address range.

In an embodiment of the present disclosure, a memory controller may control a storage medium including a plurality of pages to which addresses are respectively allocated, the plurality of pages including a first page, and may be configured to store, in a first memory device, a valid page caching table including validity information for pages, the addresses of which fall within a preset address range among the plurality of pages, store, in a second memory device, a valid page table including the validity information for each of the plurality of pages, and based on the preset address range and the address of the first page, a status of which has changed, update status information of the first page, the status information being in the valid page caching table, or flush the valid page caching table to the second memory device.

According to the embodiments of the present disclosure, page status information may be managed using a caching table having a preset address range, and page status information collected in the caching table may be flushed to a valid page table. Therefore, the update frequency of the valid page table and overhead required to access the valid page table may be reduced.

### BRIEF DESCRIPTION OF THE DRAWINGS

FIG. 1 is a configuration diagram of a data processing system according to an embodiment of the present disclosure.

FIG. 2 is a configuration diagram of a storage medium according to an embodiment of the present disclosure.

FIG. 3 is a configuration diagram of a memory controller according to an embodiment of the present disclosure.

FIG. 4 is a diagram for describing the concept of page status information management according to an embodiment of the present disclosure.

FIGS. 5 and 6 are flowcharts for describing an operating method of a data storage device according to an embodiment of the present disclosure.

FIG. 7 is a diagram for describing the concept of management of a valid page caching table according to an embodiment of the present disclosure.

FIG. 8 is a diagram for comparing valid page table update times depending on page status information management techniques.

### DETAILED DESCRIPTION

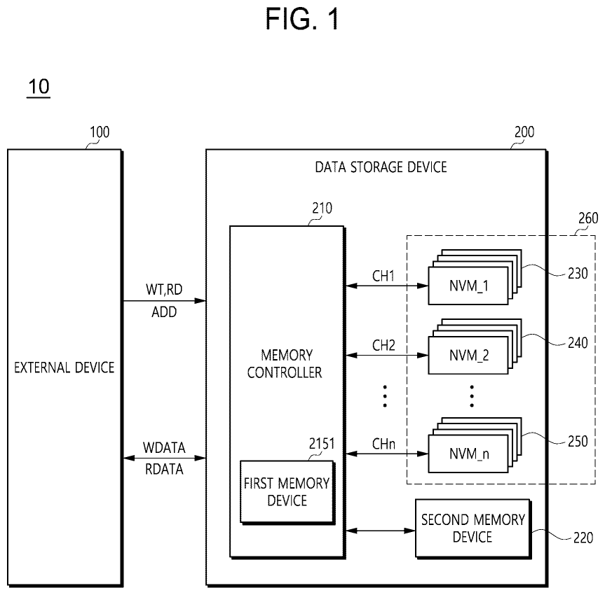

FIG. 1 is a configuration diagram of a data processing system according to an embodiment of the present disclosure.

Referring to FIG. 1, a data processing system 10 may include an external device 100 and a data storage device 200.

The external device 100 may include at least one processor. The external device 100 may be a processor itself, or an electronic device or a system that includes the processor. The external device 100 may function as a host device for the data storage device 200.

The data storage device 200 may include a memory controller 210 including a first memory device 2151, a second memory device 220, and a storage medium 260. The storage medium 260 may include at least a plurality of nonvolatile memory devices 230, 240, . . . , 250 (also indicated by NVM_1, NVM_2, . . . , NVM_n) which are electrically connected to the memory controller 210 through one or more channels CH1, CH2, . . . , CHn.

The external device 100 may transmit a write request including a write command WT, an address ADD, and write data WDATA to the data storage device 200 to write data. In response to the write request, the data storage device 200 may control the write data WDATA to be programmed to the storage medium 260.

The external device 100 may transmit a read request including a read command RD and an address ADD to the data storage device 200 to read data. The data storage device 200 may read data requested to be read RDATA from the storage medium 260 or the second memory device 220, and may transfer the read data to the external device 100.

The data storage device 200 may read or write data from or to the storage medium 260 by internally generating a read command or a write command in order to perform an internal management operation of managing the storage medium 260. The internal management operation may include various housekeeping operations, such as a wear leveling operation, a garbage collection operation, and a read reclaim operation that are performed regardless of a request from the external device 100, to efficiently use the storage space of the storage medium 260 or to ensure the reliability of data stored in the storage medium 260.

In an embodiment, the storage medium 260 may be implemented with at least one of various types of nonvolatile memory devices 230, 240, . . . , 250, such as a NAND flash memory device, a NOR flash memory device, a ferroelectric RAM (FRAM) using a ferroelectric capacitor, a magnetic RAM (MRAM) using a tunneling magneto-resistive (TMR) layer, a phase change memory device (PRAM) using chalcogenide alloys, or a resistive memory device (ReRAM) using transition metal oxides.

Each of the nonvolatile memory devices 230, 240, . . . , 250 may include a plurality of memory cells. Each of the memory cells may operate as a single-level cell (SLC) capable of storing 1 bit of data or a multi-level cell (MLC) capable of storing 2 or more bits of data. Some of the nonvolatile memory devices 230, 240, . . . , 250 may be configured to operate as a single-level cell (SLC) memory device, and some may be configured to operate as a multi-level cell (MLC) memory device. Some memory cells of each of the nonvolatile memory devices 230, 240, . . . , 250 may operate as a single-level cell (SLC), and some other memory cell may operate as a multi-level cell (MLC).

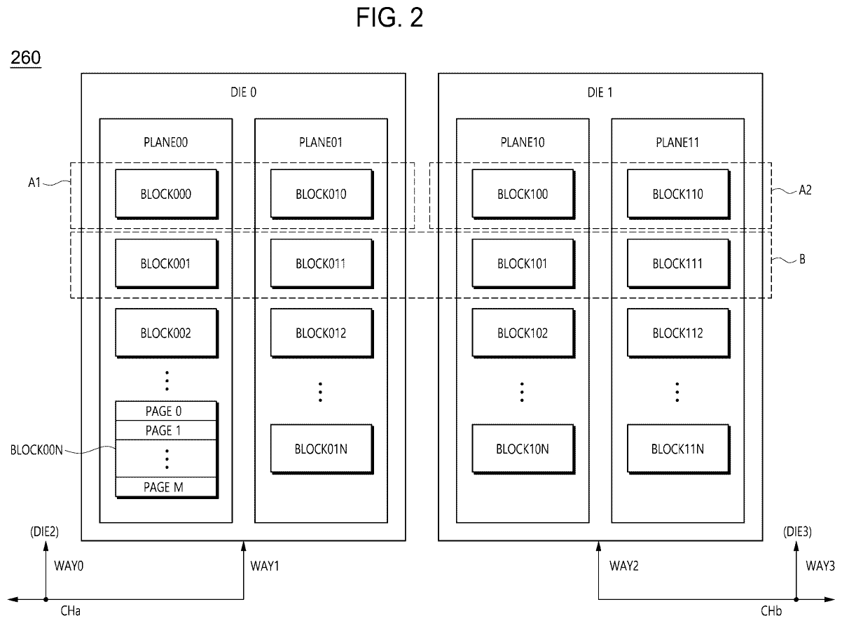

FIG. 2 is a configuration diagram of a storage medium according to an embodiment of the present disclosure.

The storage medium 260 illustrated in FIG. 2 may be at least one of the nonvolatile memory devices 230, 240, . . . , 250 (also indicated by NVM_1, NVM_2, . . . , NVM_n) illustrated in FIG. 1.

Referring to FIG. 2, the storage medium 260 according to an embodiment may include a certain number of dies DIE0 and DIE1, and each of the dies DIE0 and DIE1 may include a certain number of planes PLANE00/PLANE01 or PLANE10/PLANE11. Each of the planes PLANE00/PLANE01 and PLANE10/PLANE11 may include a certain number of memory blocks BLOCK000 to BLOCK00N, BLOCK010 to BLOCK01N, BLOCK100 to BLOCK10N, or BLOCK110 to BLOCK11N. Each of the memory blocks BLOCK000 to BLOCK00N, BLOCK010 to BLOCK01N, BLOCK100 to BLOCK10N, and BLOCK110 to BLOCK11N may be composed of a plurality of pages PAGE 0 to PAGE M. Each of the pages PAGE 0 to PAGE M may include a plurality of memory cells connected to a word line.

The storage medium 260 may receive/output data through channels CHa and CHb. Each channel CHa or CHb may receive/output data using an interleaving scheme. Each channel CHa or CHb may branch into multiple paths WAY0/WAY1 or WAY2/WAY3, sharing the corresponding channel CHa or CHb, and then the multiple paths may be connected to, for example, the dies DIE0, DIE1, DIE2, and DIE3, respectively.

Although an embodiment in which the dies DIE0/DIE2 and DIE1/DIE3 are connected to the respective paths WAY1/WAY0 and WAY2/WAY3 branching from the independent channels CHa and CHb is illustrated in FIG. 2, the embodiment of the storage medium 260 is not limited thereto.

Referring to FIGS. 1 and 2, the memory controller 210 may configure a superblock by grouping blocks simultaneously selectable from among a plurality of memory blocks.

The superblock may be configured as a combination of simultaneously selectable blocks such as by grouping and configuring (A1 and A2) memory blocks included in different planes in the same die or by grouping and configuring (B) memory blocks included in different planes in a plurality of dies.

Due to the characteristic that a program operation is performed in units of each page PAGE 0 to PAGE M and an erase operation is performed in units of each block BLOCK000 to BLOCK00N, BLOCK010 to BLOCK01N, BLOCK100 to BLOCK10N, or BLOCK110 to BLOCK11N, the memory controller 210 may manage status information of each page PAGE 0 to PAGE M, that is, whether data stored in each page PAGE 0 to PAGE M is valid, in the form of a bitmap in a valid page table VPT.

In an embodiment, although the status of each page PAGE 0 to PAGE M may be changed in the case where data is programmed or erased, where previously stored data is invalidated, where a trim or unmap command is executed, or where an internal management operation such as garbage collection or wear leveling is performed, the embodiments of the present disclosure are not limited thereto.

Referring back to FIG. 1, the first memory device 2151 may be allocated as the internal memory of the memory controller 210, for example, at least a portion of a register provided in the memory controller 210.

The first memory device 2151 may store a valid page caching table including validity information for pages falling within a preset address range. That is, the first memory device 2151 may store the valid page caching table on a preset caching unit basis. A caching size that is the size of the valid page caching table may be a value corresponding to a preset address range. The caching size may be set during the manufacturing of the data storage device 200, and may be, for example, the striping unit of pages constituting the storage medium 260, but the caching size is not limited thereto.

The second memory device 220 may store data that is transmitted or received between the external device 100 and the data storage device 200 during a write or read operation, and metadata that is related to the operation of the data storage device 200. In an embodiment, the second memory device 220 may be provided outside or inside the memory controller 210, and may include a Dynamic Random Access Memory (DRAM) or a Static Random Access Memory (SRAM).

The memory controller 210 may manage validity information for all pages constituting the storage medium 260 in the valid page table. The valid page table may be stored and updated in, for example, the second memory device 220, and may be stored in the storage medium 260 under conditions, for example, such as a power-off event, system reset, or when the valid page table size exceeds a predefined threshold requiring persistence for data integrity.

When the address of a first page, status information of which has changed, falls within the address range of the valid page caching table stored in the first memory device 2151, the memory controller 210 may update the status information of the first page in the valid page caching table.

When the address of the first page, the status information of which has changed, falls out of the address range of the valid page caching table stored in the first memory device 2151, the memory controller 210 may determine whether to flush the valid page caching table to the valid page table.

In an embodiment, when an index is assigned to the valid page caching table, the memory controller 210 may treat the valid page caching table as being in a valid state, flush the valid page caching table of the first memory device 2151 to the valid page table, and then initialize the valid page caching table. In an embodiment, when an index is not assigned to the valid page caching table, i.e., when no index is assigned to the valid page caching table, the memory controller 210 may treat the valid page caching table as being in an invalid state and then initialize the valid page caching table of the first memory device 2151 without flushing the valid page caching table to the valid page table.

The memory controller 210 may initialize a valid page caching table in which the address of the first page is not included, and may configure a valid page caching table, having the address range including the address of the first page, in the first memory device 2151, and then manage the status information of the first page.

In this way, the memory controller 210 may update the status information of pages falling within the preset address range in the valid page caching table stored in the first memory device 2151. When the address of the page, the status of which has changed, does not fall within the address range of the valid page caching table in a valid state, which is stored in the first memory device 2151, the memory controller 210 may update the valid page table that manages the validity of all pages by flushing the valid page caching table to the valid page table.

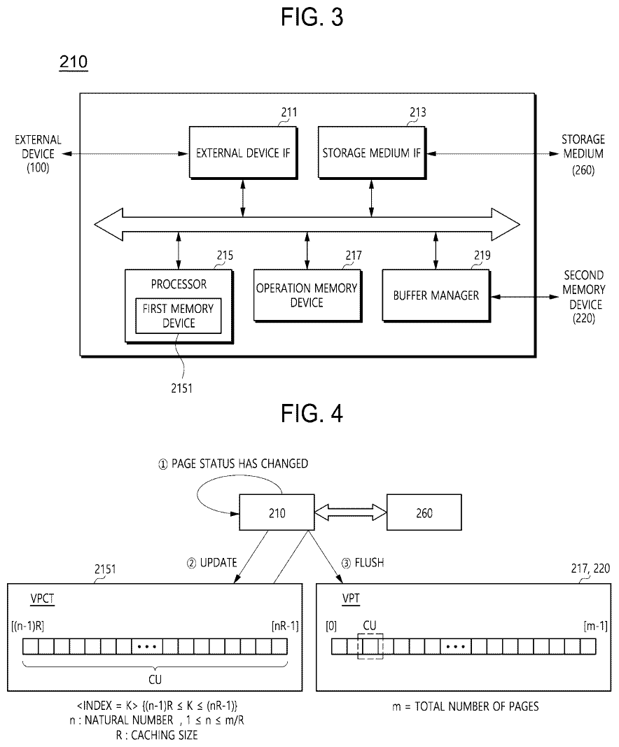

FIG. 3 is a configuration diagram of a memory controller according to an embodiment of the present disclosure.

Referring to FIG. 3, the memory controller 210 according to an embodiment may include an external device interface (IF) 211, a storage medium interface (IF) 213, a processor 215, an operation memory device 217, and a buffer manager 219.

The external device IF 211 may provide a communication channel for receiving a command and a clock signal from the external device 100 and controlling the input/output of data under the control of the processor 215. In particular, the external device IF 211 may provide a physical connection between the external device 100 and the storage medium 260.

In an embodiment, the external device IF 211 may communicate with the external device 100 based on an interface that uses at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA (SATA) protocol, a parallel-ATA (PATA) protocol, a small computer system interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, and an improved inter-integrated circuit (I3C) protocol.

The external device IF 211 may store write data provided from the external device 100 in the second memory device 220 under the control of the processor 215. Also, read data that is read from the storage medium 260 and stored in the second memory device 220 may be provided to the external device 100.

The storage medium IF 213 may provide a communication channel for signal transmission and reception between the memory controller 210 and the storage medium 260. The storage medium IF 213 may write data, temporarily stored in the second memory device 220, to the storage medium 260 under the control of the processor 215. The storage medium IF 213 may transfer read data, which is read from the storage medium 260, to the second memory device 220 and temporarily store the read data in the second memory device 220, under the control of the processor 215.

The processor 215 may be configured to operate by running firmware or software provided for various operations of the memory controller 210 on hardware. The processor 215 may be implemented in a form in which hardware and firmware or software running on the hardware are combined. In an embodiment, the processor 215 may perform functions of a flash translation layer (FTL) that manages the storage medium 260, for example, address mapping, block management, garbage collection, or wear leveling.

The processor 215 may allocate at least a portion of the register provided therein to the first memory device 2151.

The first memory device 2151 may store data required to run firmware, for example, metadata that includes a valid page caching table containing validity information for pages falling within a preset address range.

The operation memory device 217 may store firmware that is run by the processor 215. The operation memory device 217 may include a Static Random Access Memory (SRAM).

The buffer manager 219 may control the second memory device 220, such as by allocating or deallocating storage areas constituting the second memory device 220, under the control of the memory controller 210.

The memory controller 210 may store the valid page table in the operation memory device 217 or the second memory device 220.

When data is programmed to or erased from the storage medium 260, when previously stored data is invalidated, when a trim or unmap command is executed, or when an internal management operation such as garbage collection or wear leveling is performed, page status information may be changed.

When the status information of the corresponding page has changed, the memory controller 210 may determine, based on the address of a first page, the status of which has changed, and the address range of a first valid page caching table that is currently stored in the first memory device 2151, whether to reflect status information of the first page in the first valid page caching table. That is, whether the address of the first page falls within the address range of the first valid page caching table may be determined.

When the address of the first page falls within the address range of the first valid page caching table, the memory controller 210 may update the status information of the first page in the first valid page caching table.

To reflect the status information of the first page in the first valid page caching table, the memory controller 210 may identify an offset that is a location within the first valid page caching table at which the status information of the first page is to be stored, and may access the location, i.e., the offset to reflect the status information of the first page. Further, when an index is not assigned to the first valid page caching table, an index may be assigned. The first valid page caching table assigned with the index may be treated as being in a valid state.

The address of the first page may not fall within the address range of the first valid page caching table, and the first valid page caching table may be in a valid state. The memory controller 210 may update the valid page table by flushing the first valid page caching table to the valid page table. The valid page table may be stored in the operation memory device 217 or the second memory device 220. Furthermore, the memory controller 210 may initialize the first valid page caching table, and may configure a second valid page caching table, in which the status information of the first page is to be reflected, in the first memory device 2151. The second valid page caching table may be configured based on a preset address range including the address of the first page.

The address of the first page may not fall within the address range of the first valid page caching table, and the first valid page caching table may be in an invalid state. The memory controller 210 may initialize the first valid page caching table without an operation of flushing the first valid page caching table to the valid page table, and may generate the second valid page caching table, in which the status information of the first page is to be reflected, in the first memory device 2151.

To reflect the status information of the first page in the second valid page caching table, the memory controller 210 may identify an offset that is the location within the second valid page caching table at which the status information of the first page is to be stored. The memory controller 210 may access the location, i.e., the offset to reflect the status information of the first page, and may assign an index to the second valid page caching table. The second valid page caching table assigned with the index may be treated as being in a valid state.

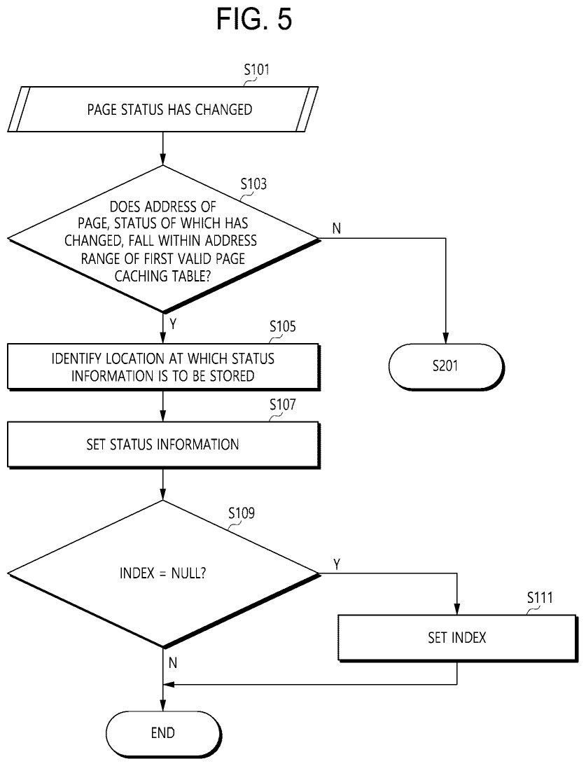

FIG. 4 is a diagram for describing the concept of page status information management according to an embodiment of the present disclosure.

The total number of pages constituting a storage medium 260 may be m, and a valid page table VPT in which status information including the validity of each of the m pages is managed may be stored in an operation memory device 217 or a second memory device 220. The valid page table VPT may store the status information in the form of a bitmap.

A valid page caching table VPCT may be stored in a first memory device 2151. The valid page caching table VPCT may be a caching unit CU in which the validity of pages falling within a preset address range from [(n−1)R] to [(nR−1)], where n is a natural number that satisfies 1≤n≤m/R, is managed and the CU may be a portion of the valid page table VPT.

The valid page caching table VPCT may store status information indicating the validity of pages falling within the preset address range from [(n−1)R] to [(nR−1)] in the form of a bitmap. Therefore, the valid page caching table VPCT may have a caching size R corresponding to the preset address range from [(n−1)R] to [(nR−1)].

When the status of a specific page has changed (\textcircled{1}), the memory controller 210 may check whether the address of the page, the status of which has changed, falls within the address range of the valid page caching table VPCT.

When it is determined that the address of the page, the status of which has changed, falls within the address range of the valid page caching table VPCT, the memory controller 210 may identify an offset that is the location within the valid page caching table VPCT at which the status information of the corresponding page is to be stored, and may then reflect the status information of the corresponding page (\textcircled{2}).

When the address of the page, the status of which has changed, does not fall within the address range of the valid page caching table VPCT, and the valid page caching table VPCT that is currently stored in the first memory device 2151 is in a valid state, the memory controller 210 may update the valid page table VPT by flushing the valid page caching table VPCT currently stored in the first memory device 2151 to the valid page table VPT (\textcircled{3}).

When the valid page caching table VPCT is flushed, the memory controller 210 may initialize the valid page caching table VPCT of the first memory device 2151 and may configure a valid page caching table VPCT having the address range including the address of the page, the status of which has changed.

An index (INDEX) may be assigned to the valid page caching table VPCT. The index (INDEX) may have any of address values falling within the address range of the valid page caching table VPCT (where INDEX=K, [(n−1)R]≤K≤[(nR−1)]).

In an embodiment, the address of the page related to status information initially stored in the valid page caching table VPCT may be set as the index of the valid page caching table VPCT, but the index is not limited thereto.

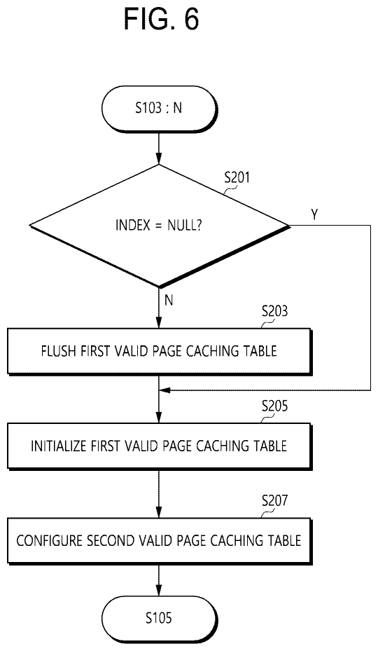

FIGS. 5 and 6 are flowcharts for describing an operating method of a data storage device according to an embodiment of the present disclosure.

Referring to FIGS. 1 to 5, when data is programmed to or erased from the storage medium 260, when previously stored data is invalidated, when a trim or unmap command is executed, or when an internal management operation such as garbage collection or wear leveling is performed, page status information may be changed in operation S101.

When status information of a first page has changed, the memory controller 210 may determine, based on the address of the first page CPA, the status of which has changed, and the address range ([(n−1)R] to [nR−1]) of the first valid page caching table that is currently stored in the first memory device 2151, whether the address of the first page CPA falls within the address range ([(n−1)R] to [nR−1]) of the first valid page caching table in operation S103.

In an embodiment, when the quotient obtained by dividing the address of the first page CPA by a caching size R is equal to the quotient obtained by dividing the index (INDEX) of the first valid page caching table by the caching size R, the memory controller 210 may determine that the address of the first page CPA falls within the address range ([(n−1)R] to [nR−1]) of the first valid page caching table.

When the address of the first page CPA falls within the address range ([(n−1)R] to [nR−1]) of the first valid page caching table (in the case of Yes in operation S103), the memory controller 210 may update the status information of the first page in the first valid page caching table.

In detail, the memory controller 210 may identify, in operation S105, an offset that is the location within the first valid page caching table at which the status information of the first page is to be stored. In an embodiment, the memory controller 210 may determine the remainder, obtained by dividing the address of the first page CPA by the caching size R. The reminder may be the offset that is the location at which the status information of the first page is to be stored.

The memory controller 210 may access the first valid page caching table based on the identified offset and then set the status information in operation S107. The status information may be managed in the form of a bitmap in such a way that a bitmap value of logic 0 indicates that the page corresponding to the offset is a valid page and a bitmap value of logic 1 indicates that the page corresponding to the offset is an invalid page.

The memory controller 210 may check whether the index of the first valid page caching table is a NULL value, that is, whether the index is assigned to the first valid page caching table, in operation S109.

In the case where the index is assigned to the first valid page caching table (in the case of No in operation S109), the memory controller 210 may terminate a status information update process. The first valid page caching table assigned with the index may be treated as being in a valid state.

In the case where an index is not assigned to the first valid page caching table (in the case of Yes in operation S109), the memory controller 210 may set the index for the first valid page caching table and terminate the status information update process in operation S111. In an embodiment, although the index of the first valid page caching table may be the address of a page related to a status information bitmap that is initially stored, the index is not limited thereto.

On the other hand, when the address of the first page CPA does not fall within the address range ([(n−1)R] to [nR−1]) of the first valid page caching table (in the case of No in operation S103), the memory controller 210 may perform the process illustrated in FIG. 6.

Referring to FIG. 6, the memory controller 210 may check whether an index is assigned to the first valid page caching table currently stored in the first memory device 2151, that is, whether the first valid page caching table is in a valid state, in operation S201.

When the index is assigned to the first valid page caching table (in the case of No in operation S201), the memory controller 210 may update the valid page table by flushing the first valid page caching table to the valid page table in operation S203. The memory controller 210 may initialize the first valid page caching table of the first memory device 2151 in operation S205.

When an index is not assigned to the first valid page caching table (in the case of Yes in operation S201), the memory controller 210 may determine that the first valid page caching table is invalid. The memory controller 210 may initialize the first valid page caching table without a process of flushing the first valid page caching table to the valid page table in operation S205.

The memory controller 210 may configure a second valid page caching table having an address range including the address of the first page in the first memory device 2151. From another aspect, the memory controller 210 may change the initialized first valid page caching table having a first address range to a second valid page caching table having a second address range in operation S207, and may perform operation S105 of FIG. 5. The address range of the second valid page caching table may be determined depending on the minimum value of n, causing a leading address ((n−1) R) to be equal to or greater than the address of the first page CPA, and the caching size R.

The memory controller 210 may identify, in operation S105, the location within the second valid page caching table at which the status information of the first page is to be stored. In an embodiment, the memory controller 210 may determine the remainder, obtained by dividing the address of the first page CPA by the caching size R. The remainder may be an offset that is the location at which the status information of the first page is to be stored.

The memory controller 210 may access the second valid page caching table based on the identified offset and then set the status information in operation S107.

The memory controller 210 may check whether the index of the second valid page caching table is a NULL value, that is, whether the index is assigned to the second valid page caching table, in operation S109.

In the case where the index is assigned to the second valid page caching table (in the case of No in operation S109), the memory controller 210 may terminate a status information update process.

In the case where an index is not assigned to the second valid page caching table (in the case of Yes in operation S109), the memory controller 210 may set the index for the second valid page caching table and terminate the status information update process in operation S111.

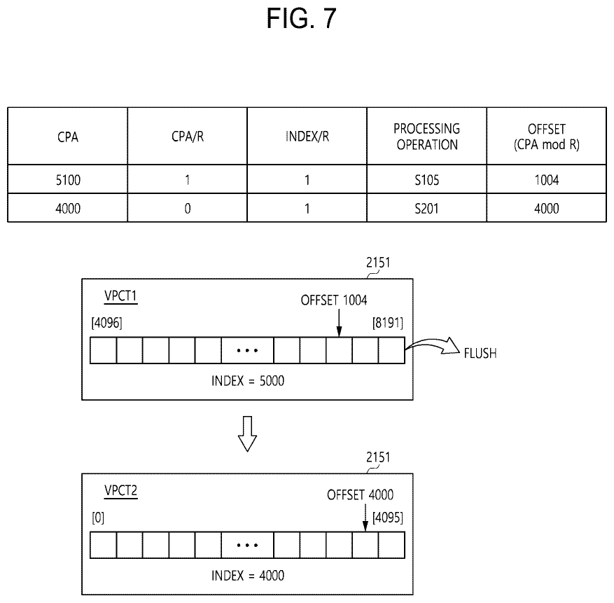

FIG. 7 is a diagram for describing the concept of management of a valid page caching table according to an embodiment of the present disclosure.

In FIG. 7 a caching size R is 4 KB (=4096) and the index (INDEX) of a first valid page caching table VPCT1 currently stored in the first memory device 2151 is 5000.

Referring to FIGS. 5 to 7, when the status of a first page having, for example, an address of 5100 has changed in operation S101, the memory controller 210 may check whether the address of the first page (CPA=5100) falls within the address range of the first valid page caching table VPCT1, based on the caching size (R=4 KB) and the index (INDEX=5000) in operation S103. For example, in the case where the quotient (1) obtained by dividing the address of the first page (CPA=5100) by the caching size (R=4 KB) is equal to the quotient (1) obtained by dividing the index (INDEX=5000) by the caching size (R=4 KB), the memory controller 210 may determine that the address of the first page (CPA=5100) falls within the address range of the first valid page caching table VPCT1.

In the case where the address of the first page (CPA=5100) falls within the address range of the first valid page caching table VPCT1 (in the case of Yes in operation S103), the memory controller may perform operation S105 of FIG. 5 to identify the location within the first valid page caching table VPCT1 at which the status information of the first page is to be stored in operation S105, and may set the status information in operation S107.

To identify the location at which the status information of the first page is to be stored, the memory controller 210 may determine the remainder (1004) obtained by dividing the address of the first page (CPA=5100) by the caching size (R=4 KB). The remainder (1004) may be the offset that is the location at which the status information of the first page is to be stored.

In the case where an index is not set for the first valid page caching table VPCT1 (in the case of Yes in operation S109), the memory controller 210 may set the address of the first page as the index of the first valid page caching table VPCT1 in operation S111.

On the other hand, when the status of a second page having an address of 4000 has changed in operation S101, the memory controller 210 may check whether the address of the second page (CPA=4000) falls within the address range of the first valid page caching table VPCT1, based on the address of the second page (CPA=4000), the caching size (R=4 KB) and the index (INDEX=5000), in operation S103. For example, in the case where the quotient (0) obtained by dividing the address of the second page (CPA=4000) by the caching size (R=4 KB) is not equal to the quotient (1) obtained by dividing the index (INDEX=5000) by the caching size (R=4 KB), the memory controller 210 may determine that the address of the second page (CPA=4000) does not fall within the address range of the first valid page caching table VPCT1.

When the address of the second page (CPA=4000) does not fall within the address range of the first valid page caching table VPCT1 (in the case of No in operation S103), the memory controller may proceed to operation S201 of FIG. 6 where the first valid page caching table VPCT1 assigned with the index (INDEX=5000) (in the case of No in operation S201) may be flushed to the valid page table in operation S203, and the first valid page caching table VPCT1 may be initialized in operation S205.

The memory controller 210 may generate a second valid page caching table VPCT2 having an address range including the address of the second page (CPA=4000) in the first memory device 2151 in operation S207. From another aspect, the memory controller 210 may change the initialized first valid page caching table VPCT1 to the second valid page caching table VPCT2, and may identify in operation S105 the location within the second valid page caching table VPCT2 at which the status information of the second page is to be stored.

The address range of the second valid page caching table VPCT2 may be determined depending on the minimum value of n, causing a leading address ((n−1) R) to be equal to or greater than the address of the second page (CPA=4000), and the caching size R. The value of n may be determined to be 1 depending on the address of the second page (CPA=4000), and the address range of the second valid page caching table VPCT2 may be determined to be a range from 0 to 4095.

To identify the location at which the status information of the second page is to be stored, the memory controller 210 may determine the remainder (4000) obtained by dividing the address of the second page (CPA=4000) by the caching size (R=4 KB). The remainder (4000) may be the offset that is the location at which the status information of the second page is to be stored.

In the case where an index is not set for the second valid page caching table VPCT2 (in the case of Yes in operation S109), the memory controller 210 may set the address of the second page (4000), which is the address of a page related to status information initially stored in the second valid page caching table VPCT2, as the index of the second valid page caching table VPCT2 in operation S111.

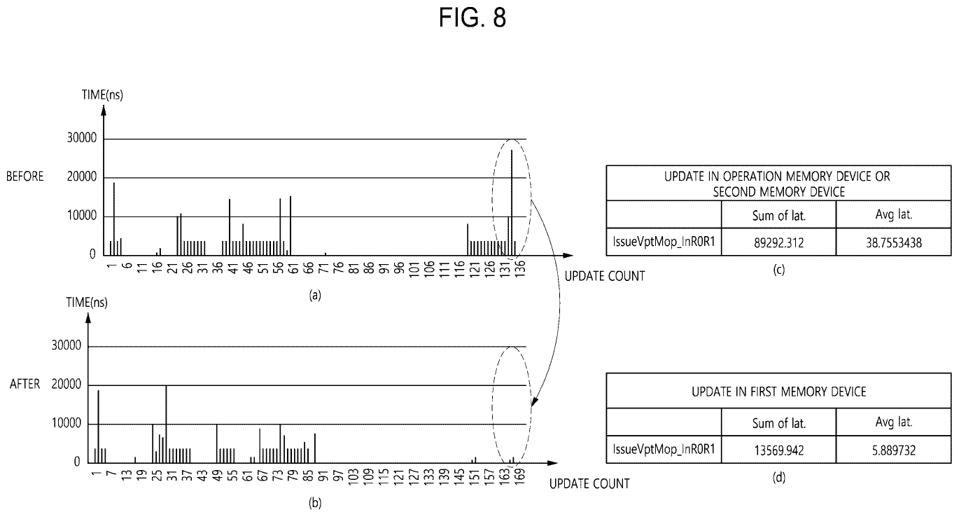

FIG. 8 is a diagram for comparing valid page table update times depending on page status information management techniques.

FIG. 8 illustrates graph (a) and the numerical table (c) thereof, which show the case where page status information is directly updated in the valid page table of the operation memory device 217 or the second memory device 220, and graph (b) and the numerical table (d) thereof, which show the case where the page status information is updated in the valid page caching table of the first memory device 2151.

When the page status information is directly updated in the valid page table of the operation memory device 217 or the second memory device 220, the total time required to update the status information of pages corresponding to caching units within a set address range is measured to be 89,292.312 ns, and the average update time is measured to be 38.7553438 ns.

On the other hand, when the page status information is updated in the valid page caching table of the first memory device 2151, the total time required to update the status information of pages corresponding to the caching units within the set address range is measured to be 13,569.942 ns, and the average update time is measured to be 5.889732 ns. As a result, it can be proven that the processing time is reduced to approximately 6 ns on average.

After status information for each page is updated in the first memory device 2151 that can be configured in the processor 215 of the memory controller 210, other than the operation memory device 217 or the second memory device 220, the updated status information may be flushed to the operation memory device 217 or the second memory device 220, thus reducing the time and resources required to change status information for each page.

As described above, those skilled in the art to which the present disclosure pertains will understand that the embodiments of the present disclosure may be implemented in other specific forms without departing from the spirit or essential features of this disclosure. Accordingly, it should be understood that the above-described embodiments are illustrative rather than restrictive from all aspects. The scope of the present disclosure is defined by the accompanying claims, rather than by the detailed description, and all modifications or changes derived from the meaning and scope of the claims, and equivalents thereof should be construed as falling within the scope of the present disclosure. Furthermore, the embodiments may be combined to form additional embodiments

What is claimed is:

1. A data storage device comprising:
a storage medium including a plurality of pages to which addresses are respectively allocated, the plurality of pages including a first page;
a memory controller configured to manage validity information for each of the plurality of pages;
a first memory device configured to store, under control of the memory controller, a valid page caching table including the validity information for pages, the addresses of which fall within a preset address range among the plurality of pages; and
a second memory device configured to store, under control of the memory controller, a valid page table including the validity information for each of the plurality of pages,
wherein the memory controller is configured to:
update the validity information for the first page in the valid page caching table when the address of the first page, a status of which has changed, falls within the preset address range, and
determine whether to flush the valid page caching table to the valid page table when the address of the first page, the status of which has changed, does not fall within the preset address range.

2. The data storage device according to claim 1, wherein the memory controller is configured to assign the address of the first page as an index to the updated valid page caching table when no index is assigned to the updated valid page caching table.

3. The data storage device according to claim 1, wherein the memory controller is configured to:
when the address of the first page does not fall within the preset address range and an index is assigned to the valid page caching table,
flush the valid page caching table to the valid page table, and
initialize the valid page caching table.

4. The data storage device according to claim 3, wherein the memory controller is configured to update, after initializing the valid page caching table, the validity information for the first page in the valid page caching table.

5. The data storage device according to claim 1, wherein the memory controller is configured to initialize the valid page caching table when the address of the first page does not fall within the preset address range and no index is assigned to the valid page caching table.

6. The data storage device according to claim 5, wherein the memory controller is configured to update, after initializing the valid page caching table, the validity information for the first page in the valid page caching table.

7. The data storage device according to claim 1, wherein the memory controller is configured to:
identify an offset within the valid page caching table based on a remainder obtained by dividing the address of the first page by a size of the preset address range, and
update the validity information for the first page at a location of the valid page caching table corresponding to the offset.

8. The data storage device according to claim 1, wherein:
the memory controller comprises a processor having a register, and
the first memory device is at least a portion of the register.

9. The data storage device according to claim 1, wherein the second memory device is provided inside or outside the memory controller.

10. The data storage device according to claim 1, wherein the second memory device comprises a static random access memory (SRAM) or a dynamic random access memory (DRAM).

11. An operating method of a memory controller for controlling a storage medium including a plurality of pages, to which addresses are respectively allocated, the plurality of pages including a first page, the operating method comprising:
updating validity information for the first page in a valid page caching table, which is stored in a first memory device, when an address of the first page, a status of which has changed, falls within a preset address range of the valid page caching table; and
determining whether to flush the valid page caching table to a valid page table, which is stored in a second memory device, when the address of the first page, the status of which has changed, does not fall within the preset address range.

12. The operating method according to claim 11, further comprising assigning the address of the first page as an index to the updated valid page caching table when no index is assigned to the updated valid page caching table.

13. The operating method according to claim 11, further comprising:
when the address of the first page does not fall within the preset address range and an index is assigned to the valid page caching table,
flushing the valid page caching table to the valid page table; and
initializing the valid page caching table.

14. The operating method according to claim 13, further comprising updating, after initializing the valid page caching table, the validity information for the first page in the valid page caching table.

15. The operating method according to claim 11, further comprising initializing the valid page caching table when the address of the first page does not fall within the preset address range and no index is assigned to the valid page caching table.

16. The operating method according to claim 15, further comprising updating, after initializing the valid page caching table, the validity information for the first page in the valid page caching table.

17. The operating method according to claim 11, further comprising:
identifying an offset within the valid page caching table based on a remainder obtained by dividing the address of the first page by a size of the preset address range; and
updating the validity information for the first page at a location of the valid page caching table corresponding to the offset.

18. A memory controller for controlling a storage medium including a plurality of pages to which addresses are respectively allocated, the plurality of pages including a first page, wherein the memory controller is configured to:
store, in a first memory device, a valid page caching table including validity information for pages, the addresses of which fall within a preset address range among the plurality of pages,
store, in a second memory device, a valid page table including the validity information for each of the plurality of pages, and
based on the preset address range and the address of the first page, a status of which has changed, update status information of the first page, the status information being in the valid page caching table, or flush the valid page caching table to the second memory device.

19. The memory controller according to claim 18, wherein the valid page caching table is at least a portion of the valid page table.

20. The memory controller according to claim 18, wherein:
the memory controller comprises a processor having a register, and
the first memory device is at least a portion of the register.
